(19) United States
(12) Patent Application Publication
(10) Pub. No.: US 2025/0246822 A1
(43) Pub. Date: Jul. 31, 2025

(54) CONNECTOR AND METHOD FOR SIMULTANEOUS COUPLING OF MULTIPLE ELECTRICAL CONTACTS IN A CONNECTOR

(71) Applicant: Harting International Innovation AG, Biel (CH)

(72) Inventor: Pei-Chuan Fu, San Francisco, CA (US)

(73) Assignee: Harting International Innovation AG, Biel (CH)

(21) Appl. No.: 19/033,109

(22) Filed: Jan. 21, 2025

Related U.S. Application Data
(60) Provisional application No. 63/625,429, filed on Jan. 26, 2024.

(30) Foreign Application Priority Data
Jun. 3, 2024 (GB) 2407836.2

(51) Int. Cl. H01R 4/48; H01R 13/40

(52) U.S. Cl. CPC H01R 4/48; H01R 13/40

(57) ABSTRACT

An electrical connector includes a base having multiple conductors, and a sliding coupler coupled to the base and having multiple engagement surfaces each arranged so that, when the sliding coupler is mounted on the base, each engagement surface is aligned with a respective one of the conductors. At least a portion of the sliding coupler is movable relative to the base to vary a distance between each engagement surface and the respective one of the conductors.

### RELATED APPLICATIONS

This application claims the benefit of priority of U.S. Provisional Application No. 63/625,429, filed on Jan. 26, 2024, and GB Application No. GB2407836.2, filed Jun. 3, 2024. The entire contents of those applications are relied upon and incorporated herein by reference in their entirety.

### TECHNICAL FIELD

The present disclosure relates generally to a method of assembly and a connector designed to permit simultaneous coupling of multiple electrical contacts.

### BACKGROUND

Connectors for connecting cables with multiple wires, strands or conductors often have a complex design. In particular, contacting each conductor of the cable with a corresponding electrical contact is complicated and can require individual connection operations like installation of a screw, crimp, clamp, press-fit or the like for each connection. However, multiple manual connections are often disadvantageous for use in industrial connectors, as they require a considerable amount of time for assembly and/or disassembly, are prone to inconsistent connection integrity, and can be unsuitable for certain harsh environments with high temperature fluctuations, dirt and vibrations.

### SUMMARY

In at least some implementations, an electrical connector includes a base having multiple conductors, and a sliding coupler coupled to the base and having multiple engagement surfaces each arranged so that, when the sliding coupler is mounted on the base, each engagement surface is aligned with a respective one of the conductors. At least a portion of the sliding coupler is movable relative to the base to vary a distance between each engagement surface and the respective one of the conductors.

In at least some implementations, the conductors define or are carried on individual posts, and the sliding coupler includes multiple voids in which the posts are received when the sliding coupler is mounted on the base, and wherein the engagement surfaces are defined by a surface that defines part of the void. In at least some implementations, the posts extend from the base to a free end, a centerline of the posts defines a first direction in which the sliding coupler is received on the base with each post in a respective void, and wherein the at least a portion of the sliding coupler that is movable relative to the base moves in a second direction that is perpendicular to the first direction.

In at least some implementations, the sliding coupler is defined by a unitary body that moves all at once, without relative movement between any surfaces or features of the sliding coupler.

In at least some implementations, the sliding coupler includes a first part and a second part, and wherein movement of the sliding coupler is accomplished with relative movement between the first part and the second part. In at least some implementations, the sliding coupler includes a spring between the first part and the second part, and wherein the spring applies a force tending to increase the distance between the first part and the second part.

In at least some implementations, an electrical connector includes a base having multiple conductors spaced apart from each other and extending in a first direction, and a sliding coupler having multiple passages spaced apart from each other. Each passage is defined in part by a respective engagement surface, and each passage extends in the first direction. The sliding coupler is coupled to the base with each conductor received in a respective one of the passages, and at least a portion of the sliding coupler is movable relative to the base to vary a distance between each of the engagement surfaces and the respective ones of the conductors received in the passages partly defined by the engagement surfaces so that the sliding coupler and base are adapted to clamp a wire between the multiple engagement surfaces and the multiple conductors.

In at least some implementations, the at least a portion of the sliding coupler that is movable relative to the base is movable in a second direction that is not parallel to the first direction. In at least some implementations, the second direction is perpendicular to the first direction.

In at least some implementations, the sliding coupler is defined by a unitary body that moves all at once, without relative movement between any surfaces or features of the sliding coupler.

In at least some implementations, a method of assembling an electrical connector, includes coupling a sliding coupler with a base, positioning multiple wires adjacent to respective ones of multiple conductors of the base, and moving at least part of the sliding coupler relative to the base so that the sliding coupler clamps the multiple wires against the respective ones of the multiple conductors.

In at least some implementations, the at least a part of the sliding coupler moves relative to the base in a second direction that is perpendicular to the first direction. In at least some implementations, the entire sliding coupler moves in the same direction. In at least some implementations, the sliding coupler includes a first part and a second part, and wherein movement of the sliding coupler is accomplished with relative movement between the first part and the second part. In at least some implementations, the sliding coupler includes a spring between the first part and the second part, and wherein the spring applies a force tending to increase the distance between the first part and the second part, and wherein the wires are positioned adjacent to the respective ones of the conductors while the first part and second part are moved closer to each other against the force of the spring and then the first part and second part are allowed to move apart under the force of the spring.

### BRIEF DESCRIPTION OF THE DRAWINGS

The following detailed description of preferred implementations and best mode will be set forth with regard to the accompanying drawings, in which:

FIG. 1 is an exploded perspective view of an electrical connector including a base and a sliding coupler with the sliding coupler shown in a first position;

FIG. 2 is an exploded perspective view of the electrical connector in FIG. 1 showing the sliding coupler in a second position;

FIG. 3 is a perspective view of the electrical connector with the sliding coupler mounted on the base and with the sliding coupler in the second position;

FIG. 4 is a perspective view of the electrical connector with the sliding coupler mounted on the base and with the sliding coupler in the first position;

FIG. 5 is a perspective view of an electrical connector including a base and a sliding coupler;

FIG. 6 is a side sectional view of the connector showing the sliding coupler in an open or first position;

FIG. 7 is a side sectional view similar to FIG. 6 and showing the sliding coupler in a closed or second position;

FIG. 8 is a perspective view of an electrical contact that is part of the connector, and shown in an unconnected state and without a wire end inserted therein;

FIG. 9 is a perspective view of the electrical contact of FIG. 4 shown in a connected state with a wire end inserted therein and electrically coupled to the electrical contact;

FIG. 10 is a sectional view taken generally along line 10-10 in FIG. 6; and

FIG. 11 is a sectional view taken generally along line 11-11 in FIG. 7.

### DETAILED DESCRIPTION

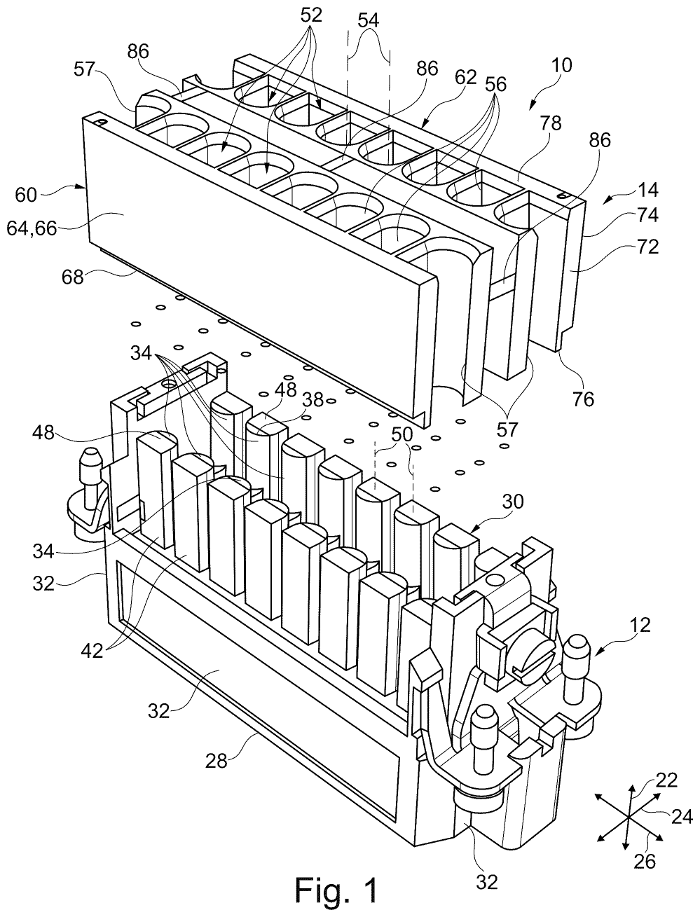

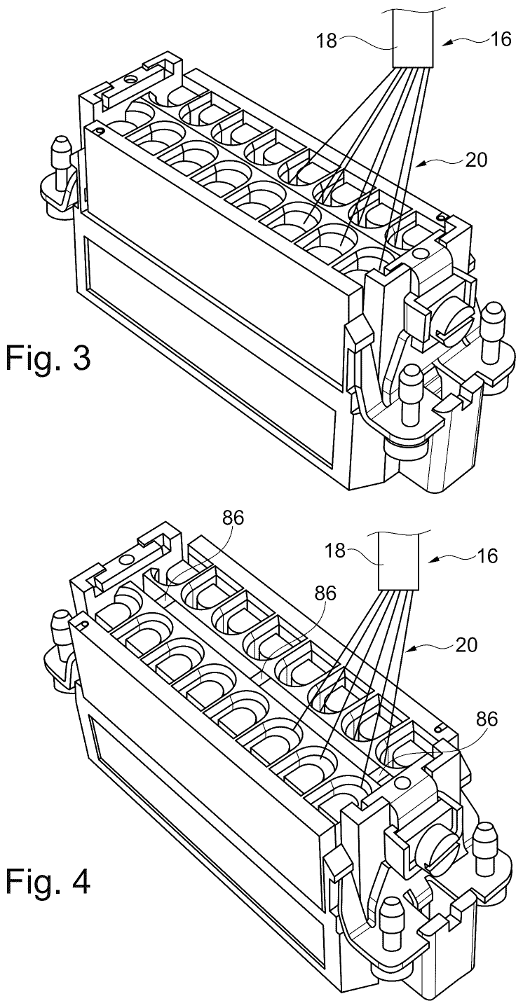

Referring in more detail to the drawings, FIGS. 1-4 illustrate an electrical connector 10 having a discrete base 12 and a discrete sliding coupler 14 that is separate from and mountable to the base 12. In the example shown, the electrical connector 10 is a fixed-type connector having a base 12 that is adapted to be connected to a structure, like a bulkhead, cabinet, wall or the like, although other connector types may be constructed and arranged as described herein. A cable 16 (FIGS. 3 and 4) including an outer sheath 18 and multiple wires 20 within the sheath 18, or other arrangement including multiple wires 20, may be coupled to the connector 10, as set forth herein.

In this disclosure, for ease of description, the term “direction” may be used to denote an angle of a line, where a line is understood to extend in two opposite directions. In this way, a first direction or vertical direction may include both up and down to extend in a direction parallel to or along the general height of the body (denoted by line 22 in FIG. 1), where such an interpretation is not inconsistent or in conflict within a given context. The same is true for a second or lateral direction to extend in a direction parallel to or along the general width of the body (denoted by line 24) and a third or longitudinal direction to extend in a direction parallel to or along the general length of the body (denoted by line 26), as used herein.

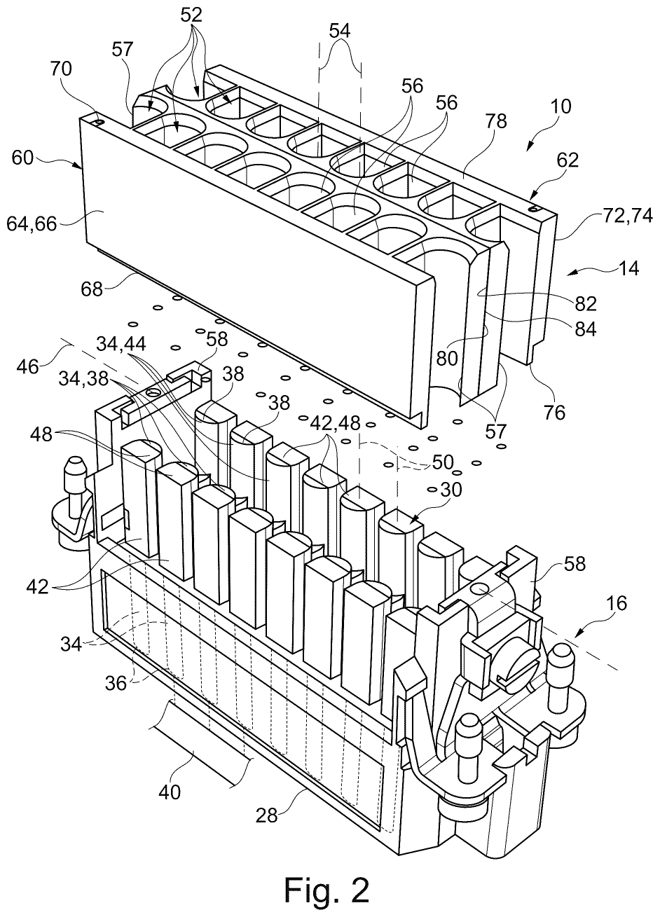

With reference to FIGS. 1 and 2, the base assembly (or “base”) 12 includes main body, conductors 34 extending outward from the main body, and end walls 58. The base 12 has a bottom surface 28 and an opposite top surface 30 and may have one or more walls 32 extending to the bottom surface 28, as desired. While shown as being a generally rectangular cube, the base 12 may have other shapes. The base 12 includes or carries multiple conductors 34 elongated in the first direction and made of electrically conductive material, like various metals (e.g. aluminum and copper). The conductors 34 may be exposed and/or accessible from the top surface 30 and may, as shown in FIG. 2, extend in the first direction 22 from a first end 36 to a second end 38 with the second end 38 being closer to the top surface 30 than the first end 36. At the first end 36 or between the first end 36 and the second end 38, the conductor 34 may be electrically connected to another component 40, such as a wire of a second cable, a conductive trace on a circuit board, a fuse, or the other electrical component. When a wire 20 from the cable 16 is electrically coupled to the conductor 34, the wire 20 is likewise electrically connected to the other electrical component 40.

In at least some implementations, the conductors 34 define or are carried on individual posts 42 elongated in the first direction, so that multiple conductors 34 are provided, spaced apart about the base 12. In the example shown, the conductors 34 are spaced apart from each other and arranged in two rows, where the rows extend in the third direction 26 and are spaced apart in the second direction 24. The conductors 34 have contact surfaces 44 elongated in the first direction, that are at least part of an outer surface of conductors, and extend in the first direction and in the third direction. As shown in the illustrated embodiment, each post 42 can have an arch shape cross-section, with a flat post bottom, flat post sides, and a rounded (e.g., half-circle) post top, with the post top positioned inwardly and closest to the base center plane 46, though other suitable shapes and positions can be utilized. The conductor 34 can be a thin sheet that is rounded and is coupled (e.g., adhered or fastened) to the surface of the post top.

In the example shown, the rows of conductors 34 and posts 42 are provided on opposite sides of a center plane 46 of the base 12, and the contact surfaces 44 face inwardly toward the center plane 46, where the conductors 34 are carried by, backed or otherwise supported by posts 42 of the base 12 with the conductors 34 covering at least part of an outer surface of the posts 42. The posts 42 may have a first proximal end that is mounted to the main body of the base 12 to be cantilevered to the base 12 and extend to a second, free end 48, and the posts 42 may be spaced apart from each other, in at least some implementations. In some embodiments, the posts 42 can be rigid and fixedly mounted at the first end to the base 12 so that the free end 48 does not move when mating with the sliding coupler 14, and in other embodiments the posts 42 can be mounted and somewhat flexible to allow for some movement when mating with the sliding coupler 14. A centerline 50 of each post 42 may extend in the first direction. Of course, other arrangements of the conductors 34 may be utilized wherein the conductors 34 have contact surfaces 44 that are accessible by wires 20 inserted adjacent to the conductors 34, preferably all in the same direction, as noted herein.

The sliding coupler 14 has a body with multiple wire passages, called voids 52 herein that are elongated in the first direction, and that are arranged complementarily to the posts 42, so that multiple posts 42, and hence, multiple conductors 34, are simultaneously each received in respective one of the voids 52. The voids 52 may have a centerline 54 that extends in the first direction such that the voids 52 are parallel to or generally parallel to the posts 42 or to the contact surfaces 44 of the conductors 34.

While the connector 10 shown has a like number of posts 42 and voids 52 so that each post 42 is received in a void 52 and there are no empty voids 52, or no posts 42 not in a void 52, this is not required. Further, while each post 42 is shown to include a conductor 34, this also is not required, nor is each conductor 34 required to be supported or associated with a post 42 (in this regard, the conductors 34 may define posts carried by the base 12). Each void 52 may be defined at least in part by an engagement surface 56 that is elongated in the first direction. The engagement surfaces 56 are arranged opposite to the contact surfaces 44 of the conductors 34, and movement of the coupler 14 changes the distance between the engagement surfaces 56 and the contact surfaces 44 to selectively clamp wires 20 received between them, as set forth in more detail below. Some or all of the voids 52 can be fully enclosed radially, relative to the centerline 54 thereof, and thus define an enclosed wire passage open only at opposite ends, with material of the sliding coupler 14 fully surrounding these voids 52 between the ends, but other arrangements may be used. For example, in the example shown, there are openings 57 to the voids 52, between the ends of the voids 52, at opposite ends of the sliding coupler 14 that are elongated in the first direction. In assembly on the base 12, these voids 52 are arranged adjacent to oppositely arranged, upstanding end walls 58 of the base 12, in this example. The openings 57 in conjunction with the upstanding end walls 58 can provide tolerance compensation, i.e. greater play, which can make assembly easier, e.g. less force required.

In the example shown in FIGS. 1-4, the sliding coupler 14 comprises a body assembly that includes a first body part 60 and a second body part 62 that are movable relative to each other. The first part 60 includes an outer wall 64 and multiple voids 52 inboard of an outer surface 66 of the outer wall 64. The voids 52 extend entirely (or at least partly) through the first part 60 in the first direction between a lower surface 68 of the first part 60 and an upper surface 70 of the first part 60. The voids 52 have a first void proximal end opening that is accessible at the lower surface(s) 68, 76, and a second void distal end opening that can be accessible at the upper surfaces 70, 78. The voids 52 of the first part 60 are arranged to receive at least partially therein the posts 42 of one row of the base 12. The second part 62 may be formed similarly, and may be a mirror image of the first part 60, and have an outer wall 72 on an opposite side of the sliding coupler 14 as the outer wall of the first part 60, and voids 52 inboard of an outer surface 74 of the outer wall 72 and extending from a lower surface 76 to the upper surface 78 of the second part 62. The voids 52 of the second part 62 are arranged to receive at least partially the posts 42 of the other row of the base 12. The terms upper and lower are not intending to limit the orientation of the connector in use, and are used for ease of reference and with regard to the orientation of the connector shown in the drawings. It is recognized that the connector 10 may be used in any orientation and that, in use, the lower surface may be vertically oriented above the upper surface (e.g. with respect to gravity) in some orientations. As used herein, the upper surface(s) 70, 78 of the sliding coupler 14 (i.e. each part thereof, when formed in multiple parts) faces away from the base 12 and the lower surface(s) 68, 76 is received on the base 12 and the posts 42 extend therethrough.

Each void 52 may be defined, at least in part, by an engagement surface 56. Each engagement surface 56 is arranged so that when the sliding coupler 14 is assembled onto the base 12, with the posts 42 received through the lower surfaces 68, 76 of the first and second parts 60, 62, each engagement surface 56 is aligned and adjacent to a respective one of the conductors 34. The voids 52 may have any desired shape and the sliding coupler 14 may cover, or overlap in the first direction, the entire length of the conductors 34 (dimension in the first direction) and may cover all of the posts 42 in the first direction, with the free ends of the posts 42 recessed within the voids 52 and visible at an outer end of the voids 52 at the top surface(s) 70, 78, in at least some implementations. As shown in the illustrated embodiment, each void 52 can have shape that is similar to and slightly larger than, the post 42 and conductor 34. Namely, each void 52 has an arch shape cross-section, with a flat void bottom, flat void sides, and a rounded (e.g., half-circle) void top, with the void top positioned inwardly and closest to a void center plane, though other suitable shapes and positions can be utilized.

In other embodiments, the distal void end opening at the upper surface(s) 70, 78 can be at least partially closed (e.g., covered by a cover) so that the distal void end opening is smaller in size (e.g., diameter) than the size of the respective void 52, but sufficient in size to receive the cable 20. The smaller void opening can be aligned with the location (engagement area) at which the cable 20 is to be received, such as for example between the engagement surface 56 and the conductor 34, so that the distal void opening can direct the cable 20 to the desired engagement area.

In the example shown, and with reference to FIG. 2, the first part 60 and second part 62 include inner planar surfaces 80, 82 that are adjacent to each and on opposite sides of a centerline 84 of the sliding coupler 14, which extends in the third direction, and the voids 52 in each part may be spaced along the third direction. In this example, the parts 60, 62 are capable of relative movement toward and away from each other. In at least some implementations, the sliding coupler 14 is assembled onto the base 12 on the first direction, and the first and second parts 60, 62 of the sliding coupler 14 are movable in the second direction, parallel to a plane including the second and third directions, and perpendicular to the first direction.

As shown in FIGS. 1 and 4, one or more biasing members 86 are connected to both the first part 60 and the second part 62, for example, about the inner surfaces 80, 82 thereof, and provide a force on the parts 60, 62 tending to separate the inner surfaces 80, 82 (e.g. increase a distance between them). The biasing members 86 may be springs, such as coil springs or leaf springs arranged to provide a force on one or both parts 60, 62 in the second direction, and yieldable to a higher force to permit the parts 60, 62 to move toward each other, as noted later. The one or more springs 86 may be formed from any suitable material, and may be metal in at least some implementations. In at least some implementations, the biasing members 86 could be flexible portions of one or both the first part 60 and second part 62, and formed in one-piece with the part(s), such as by a cantilevered finger of material that flexes under force and resiliently returns toward an unflexed or less flexed state when the force is reduced or terminated. The basing members 86 can also be configured (or other guides or features can be provided) to prevent or reduce movement of the parts 60, 62 in the first and third directions with respect to each other.

Assembly of the electrical connector 10 will be described with reference to FIGS. 1-4. In FIG. 1, the sliding coupler 14 is shown fully removed from the base 12 and with the first part 60 and the second part 62 in a first position with the inner surfaces 80, 82 thereof separated by a first distance by the biasing member(s) 86. In at least some implementations, to assemble the sliding coupler 14 on the base 12, the parts 60, 62 of the sliding coupler 14 are moved together to or toward a second position against the force of the biasing member(s) 86, as shown in FIG. 2, wherein the inner surfaces 80, 82 are in contact with each other or spaced apart by a second distance that is less than the first distance. Thereafter, the lower surface of the coupler 14 is aligned with the base 12 so that the posts 42 are aligned with the lower surface of the voids 52, the sliding coupler 14 is moved in the first direction relative to the base 12, and each of the posts 42 are simultaneously received within a respective one of the voids 52, as shown in FIG. 3, whereby the post 42 and conductor 34 are slidably received in the void 52.

In this position, with parts 60, 62 of the sliding coupler 14 in the second position, the engagement surfaces 56 of the sliding coupler 14 are spaced from the conductors 34 of the base 12. In this position, the ends of wires 20 can readily be inserted through the open, upper ends of the voids 52 and between the engagement surfaces 56 and the conductors 34, with each wire 20 installed at least partly in a respective one of the voids 52 and relative to a respective one of the conductors 34. Thereafter, the force holding the parts 60, 62 of the sliding coupler 14 in the second position can be removed to permit the biasing member(s) 86 to move the first and second parts 60, 62 away from each other and back to or toward the first position. This moves the engagement surfaces 56 toward and into contact with the wires 20, which presses the wires 20 against the conductors 34 to electrically couple the wires 20 and conductors 34, and to provide a force retaining the wires 20 within the voids 52 and preventing unintended disconnection of the wires 20. Thus, the bare wire 20 is sandwiched between the engagement surface 56 and the conductor 34 of the post 42. Electrical conduction is not needed between the wires 20 and the sliding coupler 14, and the parts 60, 62 of the sliding coupler 14 may be formed from an electrically nonconductive or insulating material.

Desirably, the assembly process can be automated with an up-down assembly direction and with movement occurring in two perpendicular directions, e.g., lateral or longitudinal direction. With the base 12 positioned relative to an automated assembly device with the posts facing upwardly, the sliding coupler 14 can be manipulated in the second direction by an end effector of a robot or other device, and installed on the base 12 in the first direction. The wires 20 can be installed in the first direction by a second end effector or device, and then the first end effector can release the sliding coupler 14 and permit the biasing member(s) to separate the first and second parts 60, 62 and ensure sufficient contact between the wires 20 and conductors 34. If desired, the sliding coupler 14 and base 12 can conveniently be provided as an integrated unit before assembly/connection of the wires 20, with the sliding coupler 14 already installed on the base 12 and with the biasing member(s) holding the engagement surfaces 56 against the conductors 34 to retain the sliding coupler 14 on the base 12. In this way, a wire connection process involves only squeezing the first and second parts 60, 62 of the sliding coupler 14 together, inserting the wires 20 and then releasing the sliding coupler parts 60, 62.

As shown and described, the post 42 and conductor 34 have a same shape as the voids 52. This configuration traps the wire 20 at the desired engagement area between the conductor 34 and the void 52, and more specifically the wire 20 is trapped between the topmost portions of the void top and the post top. Because the void top and post top are curved, the wire 20 is guided to the engagement area and is discouraged from inadvertently sliding or moving outside of the engagement area where the conductor 34 may not be located. This provides a reliable mechanical and electrical contact between the conductor 34 and the wire 20. In addition, because the top of the post 42 is recessed within the void 52, the wire 20 can be more easily guided into the engagement area by moving the wire 20 against the topmost side of the void 52 and down along the side of the void 52 until the wire 20 reaches the conductor 34.

It is further noted that, in the embodiments shown, the conductor 34 extends the entire length of the post 42, from the proximal post end fixed to the main body, to the top surface 30 of the free end 48 of the post 48. However, in other embodiments, the conductor 34 need only extend partly along the post 48, namely at the proximal post end of the post 42, and need not extend to the top surface 30. It is still further noted that the posts 42 and voids 52 in each row are aligned with the posts 42 and voids 52 in the other row. However, the posts 42 and voids 52 can be offset with respect to the other row.

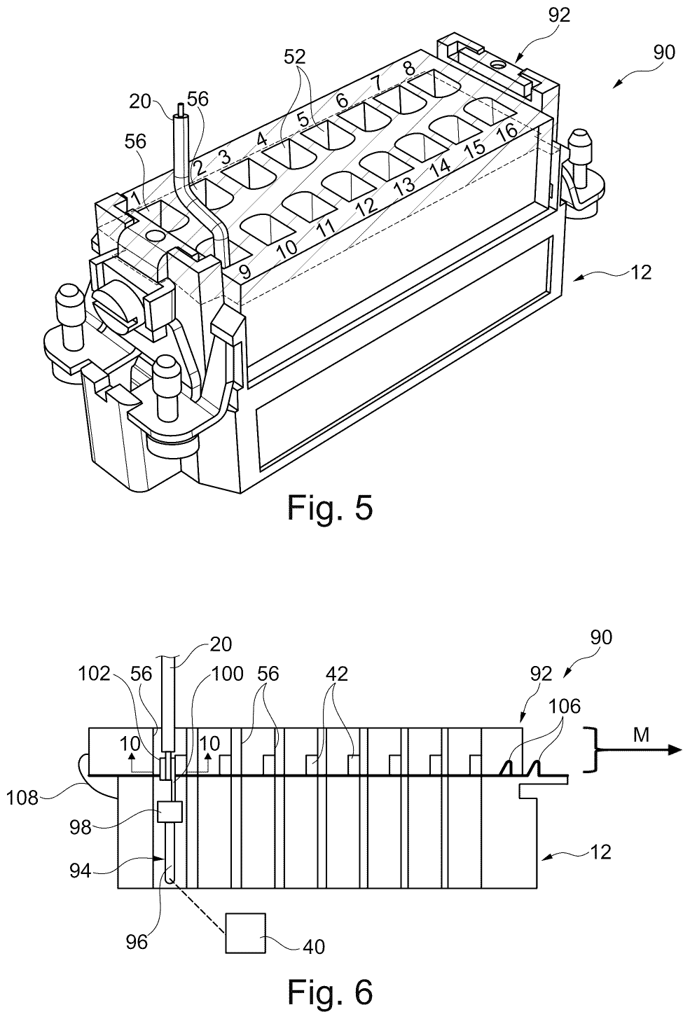

FIGS. 5-11 illustrate another implementation of an electrical connector 90 having a sliding coupler 92 (illustrated as a dashed header) and a base 12. Similar features will be given reference numbers used in description of the electrical connector 10 of FIGS. 1-4 and will not be described in detail again. The description below will focus primarily on the differences in the two electrical connectors 10, 90.

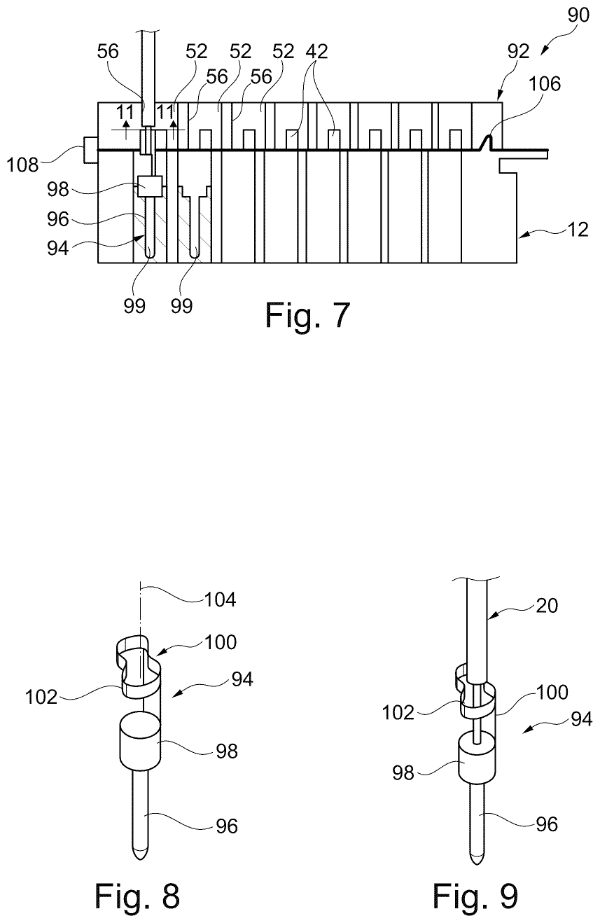

In this example, the base 12 may be constructed as described above, if desired. In the example shown, the base 12 includes conductors 94, one of which is shown in FIGS. 6-9, that are part of or fully define the posts. With reference to FIG. 8, the conductors 94 in this implementation include a lower part 96 that extends through the base 12 to the bottom surface 28, or is otherwise accessible from the bottom surface 28 for electrical connection to another electrical component 40 as noted above. The conductor 94 may include an anchor portion 98 by which it is held in the base 12 (e.g. by press-fit in a cavity 99, FIG. 7) and includes an upper portion 100 that is accessible from the opposite direction and which is arranged for receipt in a void 52 of the sliding coupler 92. In the example shown, the upper part 100 includes an annular portion 102 that defines an opening having an axis or centerline 104 arranged in the first direction and in which an end of a wire 20 is received, as described later. The conductors 94 are generally arranged for electrical communication with a wire 20, and with another electrical component 40 and may have different shapes and arrangements than that shown in the illustrated example.

In this implementation, the sliding coupler 92 is a single piece body and does not include parts or surfaces that move or are movable relative to each other, and need not include a biasing member (but could, as noted below). Instead, the sliding coupler 92 moves horizontally (indicated by the arrow, in the third direction) as a single unit from a first position in which engagement surfaces 56 of the voids 52 are spaced a first distance from the conductors 94 to a second position in which the engagement surfaces 56 of the voids 52 are closer to the conductors 94, with such movement M intended to cause electrical connection of the wires 20 to the conductors 94. An example of the movement M of the sliding coupler 92 is shown by comparison of FIGS. 6 and 7. In FIG. 6, the sliding coupler 92 is in a first position, with the engagement surfaces 56 spaced from the conductors 94, and permitting installation of the wires 20 (for simplicity, only one wire 20 is shown) in or next to the conductors.

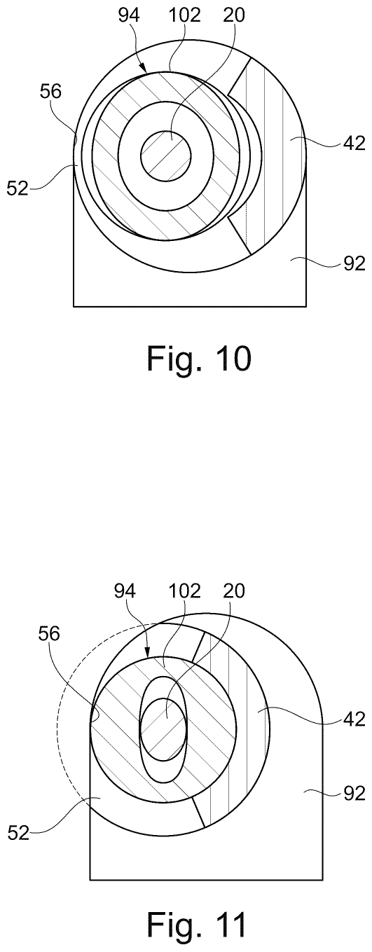

In FIG. 7, the sliding coupler 92 is in a second position, with the engagement surfaces 56 contacting the conductor 94 and/or the wire 20 to ensure firm contact between the wire 20 and conductor 94. In the example shown, with the annular conductor portion 102, movement M of the sliding coupler 92 to its second position may deform part of the annular portion 102 to firmly engage the wire 20 between portions of the annular portion 102 of the conductor 94. This is shown by comparison of FIGS. 8 and 10 which show the conductor 94 before being deformed, with FIGS. 9 and 11 which show the wire 20/conductor 94 in an assembled state and with deformation. In the example shown, the base includes upstanding posts 42 that may be provided in each void 52 to provide backing to the conductor 94 and ensure deformation of the conductors 94 or otherwise ensure good contact between the conductors 94 and wires 20 in assembly. The posts may be located on the opposite side of the conductors 94 as the engagement surfaces 56 of the sliding coupler 92 so that the conductors 94 and wires 20 are each trapped between an engagement surface 56 and a post 42. The conductor 94 could also be arranged as shown in FIGS. 1-4, with the engagement surface 56 engaging the wire 20 and holding the wire 20 in contact with the conductor, and without requiring or intending deformation, if desired.

The sliding coupler 92 can be held on the base 12 in any suitable way, such as be snap-fit retainers or retaining features 106 like tabs or flanges that have surfaces that become overlapped when the sliding coupler 92 is moved to its second position. Further, in at least some implementations, the sliding coupler 92 can be retained on the base 12 and one or more biasing members (shown diagrammatically at 108 in FIG. 6) may be provided between the base 12 and the sliding coupler 92 to permit movement M of the sliding coupler 92 relative to the base 12. For example, the biasing member(s) 108 may provide a force tending to hold or move the sliding coupler 92 in the second position, and the sliding coupler can be moved against the force of the biasing member(s) to the first position to permit installation of the wire 20 in the voids 52. Thereafter, the sliding coupler 92 can be permitted to return under the force of the biasing member(s) 108 to the second position to ensure electrical connection of the wires 20 and to retain the wires 20 in the voids.

In the example shown, the sliding coupler 92 moves in a direction parallel to the center base plane 46 of the base 12, in the third direction noted above. The sliding coupler 92 could instead be moved in the second direction, or a different direction, to connect the wires 20 to the coupler and retain the position of the wires 20. In this way, the voids 52 and conductors 94 (e.g. centerlines 104 thereof) are arranged in the first direction and movement M of the sliding coupler 92 occurs in a plane that is perpendicular to the first direction, or generally perpendicular to the first direction wherein generally includes angles up to fifteen (15) degrees from perpendicular.

The electrical connectors 10, 90 include a movable or sliding coupler 14, 92 having multiple voids 52 or wire passages spaced apart from each other, each wire passage 52 defined in part by a respective engagement surface 56, and each wire passage 52 (e.g. a centerline 54 thereof) extending in the first direction. The sliding coupler 14, 92 is coupled to a base 12 of the electrical connectors 10, 90 having multiple conductors 34, 94, with each conductor 34, 94 received in a respective one of the wire passages 52. At least a portion of the sliding coupler 14, 92 is movable relative to the base 12 to vary a distance between each of the engagement surfaces 56 and the respective ones of the conductors 34, 94 received in the passages 52 so that the sliding coupler and base 12 are adapted to clamp a wire 20 between respective ones of the multiple engagement surfaces 56 and the multiple conductors 34, 94. By this arrangement, multiple wires 20 can each installed in a respective one of the voids/wire passages 52 and engageable with a respective one of the conductors 34, 94 for simultaneous connection to the conductors upon movement M of the sliding coupler relative to the base 12 in a direction decreasing the distance of the engagement surfaces 56 from the conductors.

Further, the electrical connectors 10, 90 enable a simple method of assembly and connection for multiple wires 20 of the electrical connector 10, 90, wherein the sliding coupler 14, 92 is coupled with the base 12, multiple wires 20 are positioned adjacent to respective ones of multiple conductors 34, 94 of the base 12, and at least part of the sliding coupler 14, 92 is moved relative to the base 12 so that the sliding coupler clamps the multiple wires 20 against the respective ones of the multiple conductors 34, 94. Such a method can readily be automated to further facilitate connection of many wires 20 relative to independent conductors in an electrical connector 10, 90. Manually achieved, individual connections for each conductor are not needed, nor is visual and manual alignment of each conductor with a contact. With multiple connections may at the same time by movement of a body that simultaneously creates multiple connections, the process is greatly simplified.

The embodiments shown illustrate one way of achieving this method. However, other suitable embodiments can be provided within the spirit and scope of the invention. For example, the sliding coupler 92 can be a single unitary piece that has a single row of voids, or the voids can face outwardly, and a separate insulative plate can be placed to the outside of the sliding coupler and the wire can be trapped between the insulative plate and the conductor 34. And in that embodiment, the plate can be positioned to the sides of the post to have a single lateral motion 24 by operation of a motor or solenoid having an arm attached to the plate, and need not slide into position in the vertical direction 22.

In contrast to the embodiment shown in FIGS. 1 and 2, the sliding coupler 92 and the base 12 lack the openings to the voids 52 at the lateral ends, since no tolerance compensation is required. In FIGS. 1 and 2, sliding coupler 92 is situated between the upstanding end walls, which is not the case with sliding coupler 92 in the present embodiment.

It is further noted that the drawings may illustrate and the description and claims may use several geometric or relational terms and directional or positioning terms, such as rectangular cube, between, planar, elongated, half-circle, rounded, perpendicular, orthogonal, transverse, flat, vertical, top, bottom, side, distal, and proximal. Those terms are merely for convenience to facilitate the description based on the embodiments shown in the figures, and are not intended to limit the disclosure. Thus, it should be recognized that the disclosure can be described in other ways without those geometric, relational, directional or positioning terms. In addition, the geometric or relational terms may not be exact. For instance, walls or surfaces may not be exactly flat, perpendicular or parallel to one another but still be considered to be substantially perpendicular or parallel because of, for example, roughness of surfaces, tolerances allowed in manufacturing, etc. And, other suitable geometries and relationships can be provided without departing from the spirit and scope of the disclosure.

All terms used in the claims are intended to be given their broadest reasonable construction and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. An electrical connector, comprising:
a base having multiple conductors; and
a sliding coupler coupled to the base and having multiple engagement surfaces each arranged so that when the sliding coupler is mounted on the base, each engagement surface is aligned with a respective one of the conductors, wherein at least a portion of the sliding coupler is movable relative to the base to vary a distance between each engagement surface and the respective one of the conductors.

2. The electrical connector of claim 1 wherein the conductors define or are carried on individual posts, and the sliding coupler includes multiple voids in which the posts are received when the sliding coupler is mounted on the base, and wherein the engagement surfaces are defined by a surface that defines part of the void.

3. The electrical connector of claim 2 wherein the posts extend from the base to a free end, a centerline of the posts defines a first direction in which the sliding coupler is received on the base with each post in a respective void, and wherein the at least a portion of the sliding coupler that is movable relative to the base moves in a second direction that is perpendicular to the first direction.

4. The electrical connector of claim 1 wherein the sliding coupler is defined by a unitary body that moves all at once, without relative movement between any surfaces or features of the sliding coupler.

5. The electrical connector of claim 3 wherein the sliding coupler is defined by a unitary body that moves all at once, without relative movement between any surfaces or features of the sliding coupler.

6. The electrical connector of claim 1 wherein the sliding coupler includes a first part and a second part, and wherein movement of the sliding coupler is accomplished with relative movement between the first part and the second part.

7. The electrical connector of claim 6 wherein the sliding coupler includes a spring between the first part and the second part, and wherein the spring applies a force tending to increase the distance between the first part and the second part.

8. The electrical connector of claim 3 wherein the sliding coupler includes a first part and a second part, and wherein movement of the sliding coupler is accomplished with relative movement between the first part and the second part.

9. The electrical connector of claim 8 wherein the sliding coupler includes a spring between the first part and the second part, and wherein the spring applies a force tending to increase the distance between the first part and the second part.

10. An electrical connector, comprising:
a base having multiple conductors spaced apart from each other and extending in a first direction; and
a sliding coupler having multiple passages spaced apart from each other, each passage defined in part by a respective engagement surface, and each passage extending in the first direction, wherein the sliding coupler is coupled to the base with each conductor received in a respective one of the passages, and wherein at least a portion of the sliding coupler is movable relative to the base to vary a distance between each of the engagement surfaces and the respective ones of the conductors received in the passages partly defined by the engagement surfaces so that the sliding coupler and base are adapted to clamp a wire between the multiple engagement surfaces and the multiple conductors.

11. The electrical connector of claim 10 wherein the at least a portion of the sliding coupler that is movable relative to the base is movable in a second direction that is not parallel to the first direction.

12. The electrical connector of claim 11 wherein the second direction is perpendicular to the first direction.

13. The electrical connector of claim 10 wherein the sliding coupler is defined by a unitary body that moves all at once, without relative movement between any surfaces or features of the sliding coupler.

14. The electrical connector of claim 11 wherein the sliding coupler includes a first part and a second part, and wherein movement of the sliding coupler is accomplished with relative movement between the first part and the second part.

15. The electrical connector of claim 14 wherein the sliding coupler includes a spring between the first part and the second part, and wherein the spring applies a force tending to increase the distance between the first part and the second part.

16. A method of assembling an electrical connector, comprising:
coupling a sliding coupler with a base;
positioning multiple wires adjacent to respective ones of multiple conductors of the base; and
moving at least part of the sliding coupler relative to the base so that the sliding coupler clamps the multiple wires against the respective ones of the multiple conductors.

17. The method of claim 16 wherein the at least a part of the sliding coupler moves relative to the base in a second direction that is perpendicular to the first direction.

18. The method of claim 17 wherein the entire sliding coupler moves in the same direction.

19. The method of claim 17 wherein the sliding coupler includes a first part and a second part, and wherein movement of the sliding coupler is accomplished with relative movement between the first part and the second part.

20. The method of claim 19 wherein the sliding coupler includes a spring between the first part and the second part, and wherein the spring applies a force tending to increase the distance between the first part and the second part, and wherein the wires are positioned adjacent to the respective ones of the conductors while the first part and second part are moved closer to each other against the force of the spring and then the first part and second part are allowed to move apart under the force of the spring.
